(19) United States
(12) Patent Application Publication
(10) Pub. No.: US 2002/0081444 A1
(43) Pub. Date: Jun. 27, 2002

(54) Light protecting sheet and method for manufacturing same

(75) Inventor: Yang-Pioung Kim, Seoul (KR)

Correspondence Address: John S. Egbert, Harrison & Egbert, 7th Floor, 412 Main Street, Houston, TX, 77002, US

(73) Assignee: GMP Co., Ltd., Paju-si (KR)

(21) Appl. No.: 10/022,184

(22) Filed: Dec. 14, 2001

(30) Foreign Application Priority Data
Dec. 18, 2000 (KR) 10-2000-0078125

(51) Int. Cl. B32B 15/08

(52) U.S. Cl. 428/458; 428/346

(57) ABSTRACT

Disclosed are a light protecting sheet, capable of displaying an advertising subject of a real picture as an image of high resolution, which is advantageous in terms of low production cost, excellent productivity and light-proof characteristic, and a method for manufacturing the same. The light protecting sheet comprises an aluminum-deposited film, a transparent film coated onto one side of the aluminum-deposited film via a two-component adhesive, a white ink layer coated on the other side of the aluminum-deposited film, and a hot melt layer covering the white ink layer. In addition, such light protecting sheet can be manufactured by applying a two-component adhesive of white color on one side of an aluminum-deposited film, overlaying a transparent polyethylene terephthalate film on the adhesive, spreading white ink over the other side of the aluminum-deposited film, and coating a hot melt layer on the white ink layer.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

1. Field of the Invention

The present invention relates to a light protecting (or stop light) sheet and a method for manufacturing the same, and, in particular, to a light protecting sheet, capable of displaying an advertising subject of a real picture as an image of high resolution, which is advantageous in terms of low production cost and excellent light-proof characteristic, and a method for manufacturing the same.

2. Background of the Invention

A conventional light protecting sheet is illustrated in FIG. 1. In this figure, a filler-containing white polyethylene terephthalate film 10 (hereinafter, referred to as white PET film) is laminated on one side of an aluminum-deposited film 12 by an adhesive layer 11 provided therebetween, and a white PET film 14 is formed on the other side of the aluminum-deposited film 12 by an adhesive layer 13 provided therebetween. In such a condition, the filler-containing white PET film 10 has good light-proof characteristic but suffers from the disadvantage of the final product being expensive, due to high preparation cost. Additionally, the white film exposed to atmosphere is lower in hardness than that of a base film only made of PET and thus can be easily scratched.

### BRIEF SUMMARY OF THE INVENTION

With the problems encountered in the prior arts in mind, the present invention has an object of providing a light protecting sheet having low production cost and excellent productivity, capable of displaying an advertising subject of a real picture as an image of high resolution.

It is another object of the present invention to provide a method for manufacturing the light protecting sheet.

In accordance with an aspect of the present invention, there is provided a light protecting sheet comprising an aluminum-deposited film; a transparent film coated onto one side of the base film via a two-component adhesive; a white ink layer coated on the other side of the base film; and a hot melt layer covering the white ink layer.

In accordance with another aspect of the present invention, there is provided a method for manufacturing the light protecting sheet, comprising the following steps of: applying a two-component adhesive of white color on one side of an aluminum-deposited polyethylene terephthalate film, overlaying a transparent polyethylene terephthalate film on the adhesive, spreading white ink on the other side of the aluminum-deposited polyethylene terephthalate film, and coating a hot melt layer on the white ink layer.

### BRIEF DESCRIPTION OF THE SEVERAL VIEWS OF THE DRAWINGS

The above and other objects, features and other advantages of the present invention will be more clearly understood from the following detailed description taken in conjunction with the accompanying drawings, in which:

FIG. 1 is a cross sectional view of a conventional light protecting sheet.

FIG. 2 is a cross sectional view of a light protecting sheet according to the present invention.

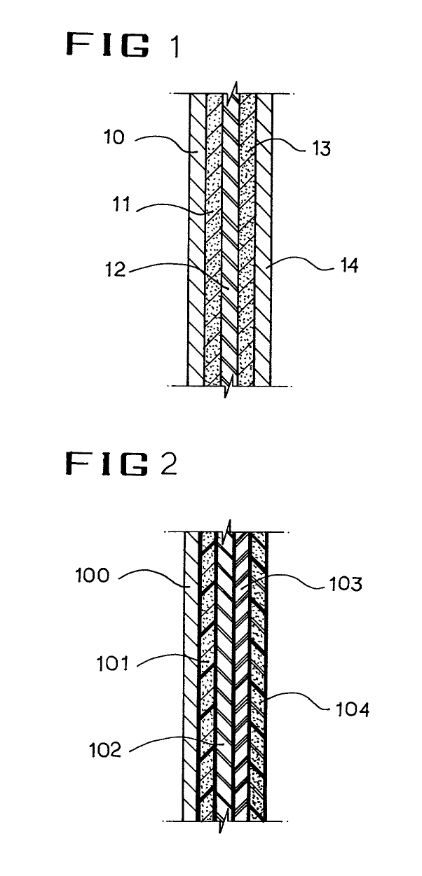

### DETAILED DESCRIPTION OF THE INVENTION

With reference to FIG. 2, there is shown a sectional view of a light protecting sheet according to the present invention. In the light protecting sheet, on the basis of an aluminum-deposited film 102, an adhesive layer 101 of white color comprising a mixture of an adhesive and a pigment is applied on one side of the base film, and a white ink-applied color paint layer 103 is formed on the other side of the base film. Then, a transparent film 100 is overlaid on the adhesive layer 101, and a hot melt layer 104 is formed on the color paint layer 103.

The transparent film 100 is made of polyethylene terephthalate, and the adhesive layer 101 shows white color by mixing the adhesive with the pigment. Such adhesive layer 101 is substituted for a conventional white PET film 10 containing fillers, and is thus advantageous in light of low production cost and improvement of productivity by improving forming workability of the sheet. On the hot melt layer 104, an advertising subject of a real picture can be directly applied.

The light protecting sheet is prepared by applying the white adhesive comprising the mixture of a two-component adhesive and a white pigment, such as titanium dioxide, aluminum hydroxide and calcium carbonate, on one side of the aluminum-deposited film 102, overlaying the transparent polyethylene terephthalate film on the adhesive, spreading the white ink on the other side of the aluminum-deposited film 102, and coating the hot melt layer on the white ink layer.

As described above, the aluminum-deposited film of the present invention having its one side applied with a two-component adhesive of white color can be substituted for expensive white PET film, and also the transparent film can be coated on its outer surface, whereby deformation and scratching attributed to lighting heat can be prevented, and an advertising subject of a real picture can be directly applied on the hot melt layer.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

I claim:

1. A method for manufacturing a light protecting sheet, comprising the following steps of:
applying a two-component adhesive of white color on one side of an aluminum-deposited film;
overlaying a transparent polyethylene terephthalate film on the adhesive;
spreading white ink over the other side of the aluminum-deposited film; and
coating a hot melt layer on the white ink layer.

2. A light protecting sheet, comprising:
an aluminum-deposited film;
a transparent film coated onto one side of the aluminum-deposited film via a two-component adhesive;
a white ink layer coated on the other side of the aluminum-deposited film; and
a hot melt layer covering the white ink layer.

3. The sheet as set forth in claim 21 wherein said two-component adhesive is mixed with a white pigment to function to fix the transparent film onto the aluminum-deposited film and to make the sheet appear white.

4. The sheet as set forth in claim 2, wherein said transparent film is made of polyethylene terephthalate.

5. The sheet as set forth in claim 2, wherein the hot melt includes an advertising subject of a real picture therein and is covered with a hot melt type laminate film to protect the advertising subject.
